(19) United States
(12) Patent Application Publication
(10) Pub. No.: US 2004/0266595 A1
(43) Pub. Date: Dec. 30, 2004

(54) Automatic machining unit

(76) Inventor: Horst Rosch, Burlafingen (DE)

Correspondence Address: OSTROLENK FABER GERB & SOFFEN, 1180 AVENUE OF THE AMERICAS, NEW YORK, NY, 100368403

(21) Appl. No.: 10/494,888

(22) PCT Filed: Jul. 7, 2003
(86) PCT No.: PCT/EP03/07230

(30) Foreign Application Priority Data
Jul. 16, 2002 (DE) 102321221

(51) Int. Cl. B23Q 3/157

(52) U.S. Cl. 483/58; 483/66; 483/69; 483/13

(57) ABSTRACT

An arrangement of a CNC machining center for an automatic machining sequence of machining operations with subsequent thermal smoothing is described in order to compact, by means of thermal smoothing, edges or decorative grooves formed by the machining. In order to integrate this thermal smoothing operation in a program sequence, a heating device is provided on the tool magazine, which heating device, controlled by the program sequence, heats a tool located in the magazine to the requisite temperature in order to then replace it in the tool spindle using the conventional gripping arm. For this purpose, a thermal coil is transferred into the heating position, in which the tool can be swung out of the cassette and can be enclosed by the coil and heated. The heating is controlled and kept at a specific value via a thermostatic thermostat preferably designed as an infrared sensor.

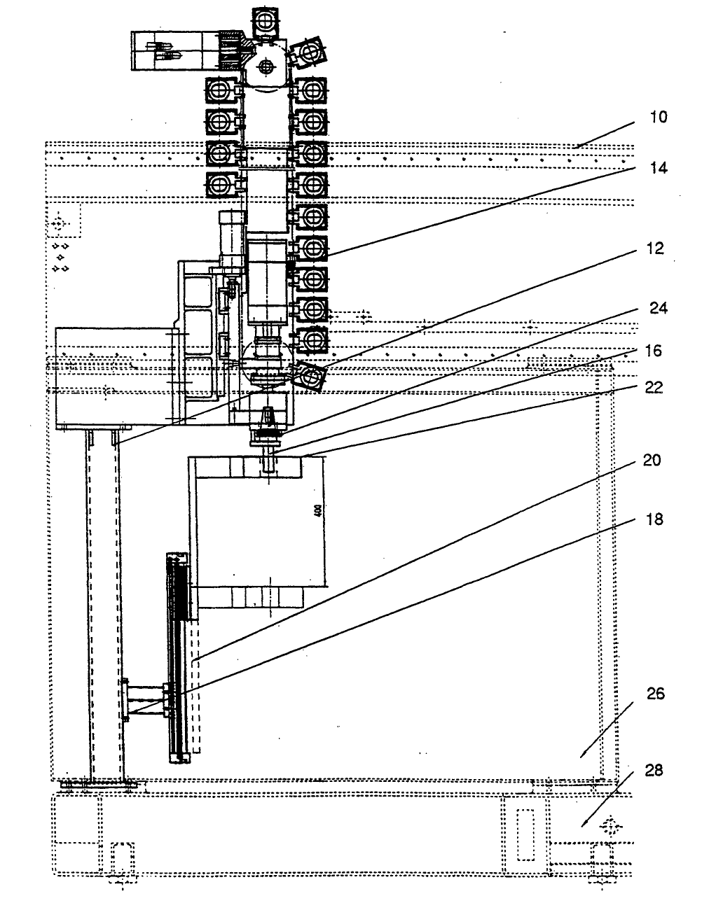

The invention relates to a CNC machine tool having a tool magazine and a program-controlled tool-change cycle for the thermal smoothing of machined wooden workpieces.

Modern furniture facades are often produced with medium density fiber boards (MDF boards). These boards have high surface compaction, resulting in smooth surfaces which require no further preparation such as sanding or priming with filler for a surface treatment, e.g. lacquering. On the other hand, edges or decorative grooves produced with a cutting action by sawing or routing must be prepared before the final treatment in order to be able to achieve a smooth surface. Rotating thermal smoothing tools, as described, for example, in DE 195 18 365 A1, are used for this purpose. DE 198 47 178 A1 describes an ultrasonically excited smoothing tool whose oscillation direction produces an angle of 45° to 90° at the contact point with the surface normal of each profile section.

Hitherto, the tool for the friction/thermal smoothing had to be specifically fetched in each case from a special rest location, or a special unit especially provided for this purpose had to be made available. The tool is constantly preheated in the special rest location. A plurality of special rest locations therefore also have to be made available for different tools. The use of the thermal smoothing tools therefore could not be included in the automatic program sequence, so that the automatic machining had to be interrupted in each case, which led to considerable prolongation of the machining time.

The object of the invention is to incorporate the thermal smoothing operation in the automatic machining sequence and thus considerably accelerate the machining operation.

The set object is achieved by the features specified in claim 1.

DE 691 10 788 T2 discloses a numerically controlled drilling device for printed circuit boards, in which the drilling tool is heated within the drilling spindle to a predetermined temperature in order to avoid temperature-induced defects at the working depth. Heating in the tool magazine is not provided.

The heating device is arranged at any desired location of the path of movement of the tool cassette in such a way that, when such a thermal smoothing tool located in the magazine arrives at the heating location, the tool and heating device are positioned in such a way that the heating can be effected during the stoppage. An induction coil is preferably used for the heating, this induction coil enclosing the thermal smoothing tool at the heating location and bringing it to the requisite temperature within a few seconds, so that the heated tool can be inserted into the spindle directly afterward by means of the existing gripper arrangement. The heating device may be arranged at any desired location of the path of movement. In the case of a chain magazine with vertical tool transport, the heating device is expediently arranged at the lowest point, and provision is made for the tool cassette with the thermal smoothing tool to be swung downward in the chain magazine at this location. The induction coil is then conveyed upward from the parking position pneumatically or hydraulically and encloses the tool for the heating operation. A temperature measurement is taken at this heating location by means of an infrared sensor, which cuts out when the requisite temperature is reached and does not initiate a heating operation if the tool still has the requisite temperature.

When the tool is replaced in the tool spindle, electric coupling to a heating cartridge is effected via a plug connector, and this heating cartridge keeps the workpiece at the requisite temperature by resistance heating during the smoothing operation.

The invention achieves the effect that, in combination with any desired cutting tools, thermal smoothing tools can also be used for an automatic machining sequence, cold thermal smoothing tools being deposited and organized in any desired number in a standard tool magazine. These tools are heated only for the machining, in which case the heating operation can be effected while the preceding operation is still taking place, for example the routing operation. This results in an increase in the flexibility and a reduction in the costs for the machining.

An exemplary embodiment of the invention is described below with reference to the drawing.

The single FIGURE of the drawing shows a schematically illustrated CNC machine tool with a standard tool-change magazine and the heating device according to the invention for thermal smoothing tools.

A magazine support 12 which carries the chain magazine 14 is arranged on the CNC machine tool 10 (only schematically illustrated) in a conventional manner. A smoothing tool 16, which is located at the lowest point of the magazine, is swung downward with the tool cassette, so that the component of the thermal smoothing tool to be heated projects downward. A pneumatic or hydraulic piston drive 20 having a carrier for an induction coil 22 is arranged in a vertically displaceable manner on an equipment holder 18 of the magazine support in such a way that the induction coil 22 encloses the smoothing tool 16 in the raised state shown in the drawing. The conventional rotary gripper 24 (not shown in detail in the drawing) grasps the heated tool and delivers the latter in a conventional manner to the tool spindle. Of the CNC machine tool 10, only the machine pedestal 26 and the base frame 28 are schematically shown, since they can be designed in the conventional manner.

However, the invention is not restricted to the arrangement of the magazine change device shown. It is important that a heating device which heats one of the tools can be brought into effect at one or more locations. The invention is also not restricted to the heating of thermal smoothing tools, but rather can be used wherever the use of heated tools is desired or necessary.

In a similar manner, such a device may also be arranged, if it is necessary, to cool a tool to a predetermined temperature before its use.

1. An automatic machine tool having a tool magazine (12) and a program-controlled tool-change cycle, in which machine tool, for the thermal smoothing of machined wooden workpieces, a heating device (22) for heating a thermal smoothing tool (16) located in a tool cassette of the magazine is provided on the tool magazine.

2. The machine tool as claimed in claim 1, having an arrangement of a CNC machining center for the automatic machining sequence of a routing operation with subsequent thermal smoothing.

3. The machine tool as claimed in claim 1, wherein the heating device is an induction coil (22).

4. The machine tool as claimed in claim 1, wherein the tool cassette with the thermal smoothing tool (16) can be swung downward at the heating position.

5. The machine tool as claimed in claim 3, wherein the induction coil (22) can be raised via a piston drive and encloses the thermal smoothing tool in the raised position.

6. The machine tool as claimed in claim 1, which comprises a temperature sensor for controlling the induction heating device.

7. The machine tool as claimed in claim 1, wherein resistance heating is provided for the smoothing tool.

8. Machine tool according to claim 7, wherein, when a thermal smoothing tool is replaced in the spindle, an electrical plug-in connection is activated which excites a thermostatically controlled heating cartridge of the resistance heating.

9. Machine tool according to one of claim 1, wherein the tool holder for the thermal smoothing tool has a torque arm.

10. The machine tool as claimed in claim 4, wherein the induction coil (22) can be raised via a piston drive and encloses the thermal smoothing tool in the raised position.
